(19) United States
(12) Patent Application Publication
(10) Pub. No.: US 2006/0248968 A1
(43) Pub. Date: Nov. 9, 2006

(54) Drive system and method

(75) Inventor: Colin Ledsome, London (GB)

Correspondence Address: RENNER OTTO BOISSELLE & SKLAR, LLP, 1621 EUCLID AVENUE, NINETEENTH FLOOR, CLEVELAND, OH, 44115, US

(73) Assignee: IMPERIAL COLLEGE INNOVATIONS LIMITED, London (GB)

(21) Appl. No.: 10/562,045

(22) PCT Filed: Jun. 23, 2004
(86) PCT No.: PCT/GB04/02691

§ 371 Date: Jul. 10, 2006

(30) Foreign Application Priority Data
Jun. 24, 2003 (GB) 0314685.9

(51) Int. Cl. G01C 19/38

(52) U.S. Cl. 74/5 R

(57) ABSTRACT

A drive system and method, the drive system comprising: an output shaft (8), which is rotatable about a rotation axis, and from which an output is in use delivered; and at least one gyroscopic rotor unit (12a, 12b), which is operably coupled to the output shaft (8) such as to drive the output shaft (8) on effecting precessional rotation of the at least one gyroscopic rotor unit (12a, 12b) about the rotation axis of the output shaft (8).

The present invention relates to a drive system and method, especially a drive system and method for providing a high-torque output at low speed. The present invention finds particular, but not exclusive, application in vehicular drive applications.

Numerous vehicular drive systems exist, and even hybrid drive systems, which incorporate prime movers, which utilize different fuel technologies, and, through selective use of the same, provide for improved fuel efficiency.

These drive systems are designed to provide a high-speed, low-torque output, and it is an aim of the present invention to provide a drive system, which can provide a high-torque output at low speed.

In one aspect the present invention provides a drive system, comprising: an output shaft, which is rotatable about a rotation axis, and from which an output is in use delivered; and at least one gyroscopic rotor unit, which is operably coupled to the output shaft such as to drive the output shaft on effecting precessional rotation of the at least one gyroscopic rotor unit about the rotation axis of the output shaft.

Preferably, the at least one gyroscopic rotor unit comprises a gyroscopic rotor, which, on applying a control force thereto in a plane including the rotation axis of the output shaft, effects precessional rotation of the at least one gyroscopic rotor unit about the rotation axis of the output shaft.

More preferably, the at least one gyroscopic rotor unit further comprises a CV coupling, which couples the gyroscopic rotor thereof to the output shaft such as to enable rotation of the gyroscopic rotor on applying a control force thereto in the plane including the rotation axis of the output shaft and effect rotation of the output shaft with precessional rotation of the at least one gyroscopic rotor unit about the rotation axis of the output shaft.

Yet more preferably, the CV coupling includes a first coupling member, which is rotatably coupled to the output shaft about a rotation axis orthogonal to the rotation axis of the output shaft, a second coupling member, which is fixed to the gyroscopic rotor, and a coupling element, which couples the first and second coupling members such that the gyroscopic rotor is rotated on rotating the first coupling member.

Still yet more preferably, the drive system further comprises: at least one rotor drive assembly, which is coupled to the first coupling member of the CV coupling such as to provide for rotation of the gyroscopic rotor.

Preferably, the gyroscopic rotor is configured such as to provide for application of a control force in one of two opposite senses, whereby the application of a control force in one sense effects precessional rotation of the at least one gyroscopic rotor unit about the rotation axis of the output shaft in one sense, thereby driving the output shaft in the one sense, and the application of a control force in the other sense effects precessional rotation of the at least one gyroscopic rotor unit about the rotation axis of the output shaft in the other sense, thereby driving the output shaft in the other sense.

In one embodiment the drive system further comprises: a control mechanism, which is operable to apply a control force to the gyroscopic rotor of the at least one gyroscopic rotor unit, and thereby control the output at the output shaft.

Preferably, the control mechanism comprises a loading body, which is rotatably and slideably disposed about the output shaft, and at least one loading link, which operably couples the loading member to the gyroscopic rotor of the at least one gyroscopic rotor unit, whereby sliding the loading body axially relative to the output shaft acts to apply a control force to the gyroscopic rotor of the at least one gyroscopic rotor unit.

More preferably, the drive system further comprises: a drive coupling assembly, which rotatably couples the loading body of the loading mechanism to the output shaft such that the loading body of the loading mechanism and the output shaft rotate in unison.

Preferably, the drive system comprises: first and second gyroscopic rotor units disposed in opposed relation about the output shaft, each comprising a gyroscopic rotor, wherein the gyroscopic rotors are rotated in opposite senses and, on application of a control force to each of the gyroscopic rotors in a plane including the rotation axis of the output shaft, effect precessional rotation of the respective gyroscopic rotor units about the rotation axis of the output shaft.

In another aspect the present invention provides a method of driving an output shaft, the method comprising the steps of: providing a drive system including an output shaft, which is rotatable about a rotation axis, and at least one gyroscopic rotor unit, which is operably coupled to the output shaft; and effecting precessional rotation of the at least one gyroscopic rotor unit about the rotation axis of the output shaft such as to drive the output shaft.

Preferably, the at least one gyroscopic rotor unit comprises a gyroscopic rotor; and the step of effecting precessional rotation comprises the step of: applying a control force to the gyroscopic rotor of the at least one gyroscopic rotor unit in a plane including the rotation axis of the output shaft, which is such as to effect precessional rotation of the at least one gyroscopic rotor unit about the rotation axis of the output shaft.

More preferably, the drive system comprises first and second gyroscopic rotor units disposed in opposed relation about the output shaft, each comprising a gyroscopic rotor, and the gyroscopic rotors being rotated in opposite senses; and the step of effecting precessional rotation comprises the step of: applying a control force to the gyroscopic rotors of the gyroscopic rotor units in a plane including the rotation axis of the output shaft, which is such as to effect precessional rotation of the gyroscopic rotor units about the rotation axis of the output shaft.

In a further aspect the present invention provides a CV coupling, comprising: a first coupling member for coupling to a first body and including a pair of opposed connection elements for providing a pivoting connection about a first pivot axis; a second coupling member for coupling to a second body and including a pair of oppositely-directed connection elements for providing a pivoting connection about the first pivot axis; and a coupling element, which couples the first and second coupling members, wherein the coupling element comprises first and second concentric annular members, with the first, outer annular member being pivotally connected to the pair of connection elements on the first coupling member and the second, inner annular member being pivotally connected to the pair of connection elements on the second coupling member, and a pair of opposed connection elements for providing a pivoting connection between the annular members about a second pivot axis, which is orthogonal to the first pivot axis.

In a yet further aspect the present invention provides a CV coupling, comprising: a first coupling member for coupling to a first body and including a part-spherical cavity and a pair of opposed guide slots; a second coupling member for coupling to a second body and including a part-spherical cavity and a pair of opposed guide slots; and a coupling element, which couples the first and second coupling members, wherein the coupling element comprises a spherical body, which is captively disposed in the cavities of the first and second coupling members, a first pair of oppositely-directed guide pins located in the pair of opposed guide slots in the first coupling member, and a second pair of oppositely-directed guide pins, disposed in orthogonal relationship to the first pair of oppositely-directed guide pins, located in the pair of opposed guide slots in the second coupling member.

Preferred embodiments of the present invention will now be described hereinbelow by way of example only with reference to the accompanying drawings, in which:

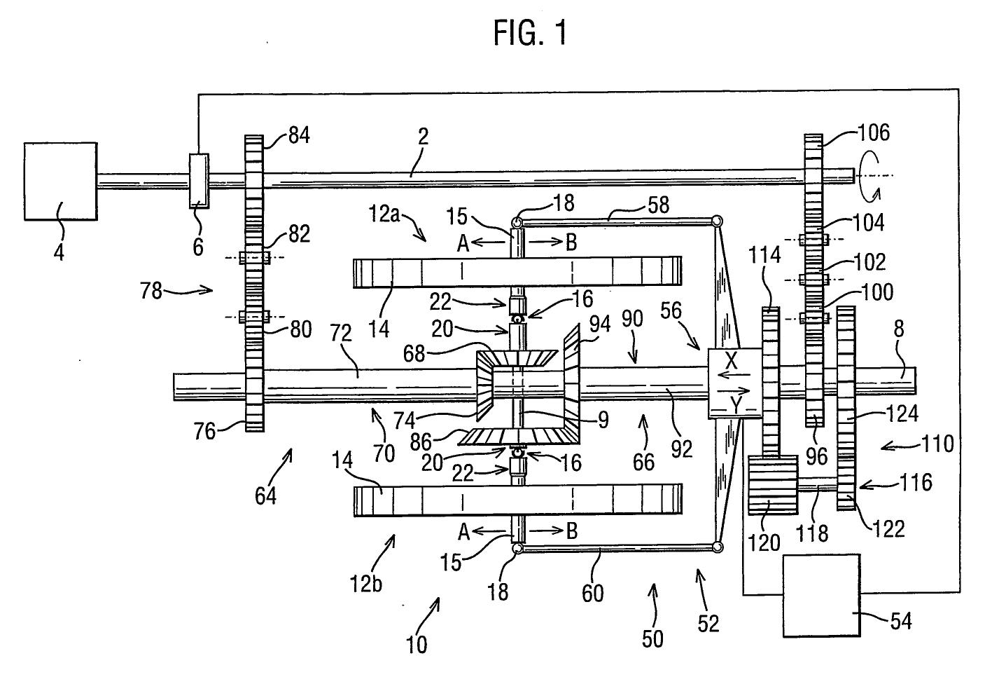

FIG. 1 schematically illustrates a drive system in accordance with a preferred embodiment of the present invention, illustrated in a non-driving configuration;

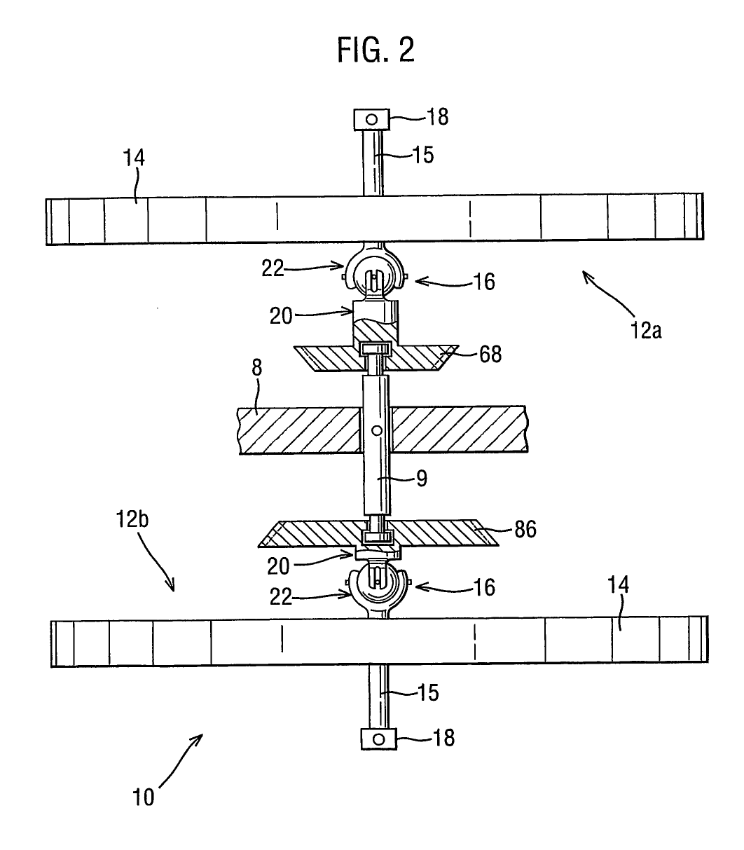

FIG. 2 illustrates the coupling of the gyroscopic rotor units to the output shaft of the drive system of FIG. 1;

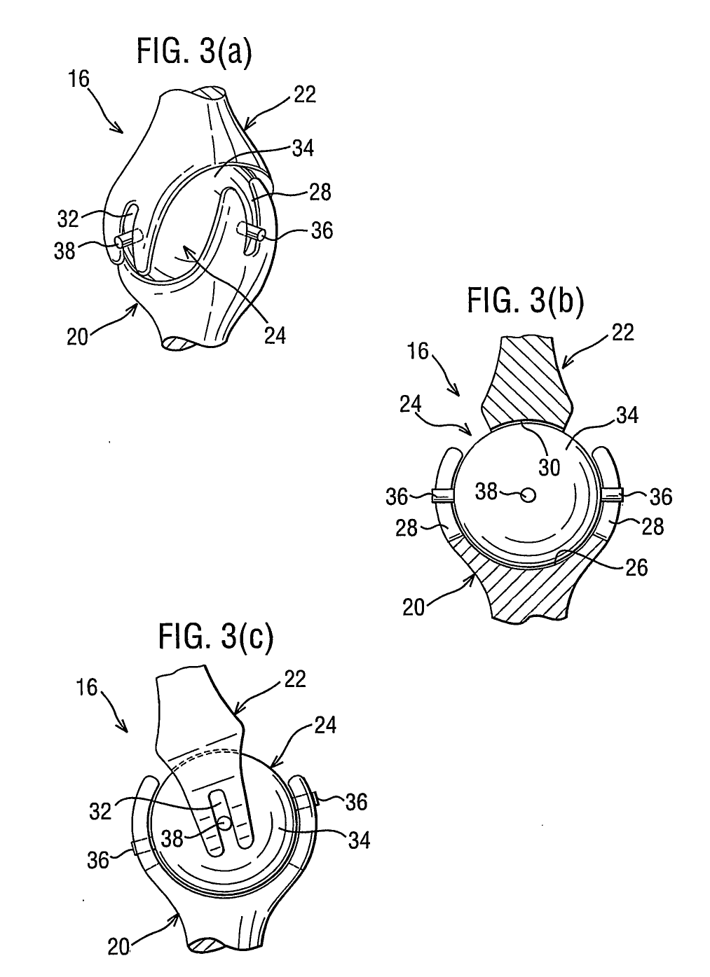

FIGS. 3(a) to (c) illustrate one embodiment of the CV coupling of one gyroscopic rotor unit of the drive system of FIG. 1;

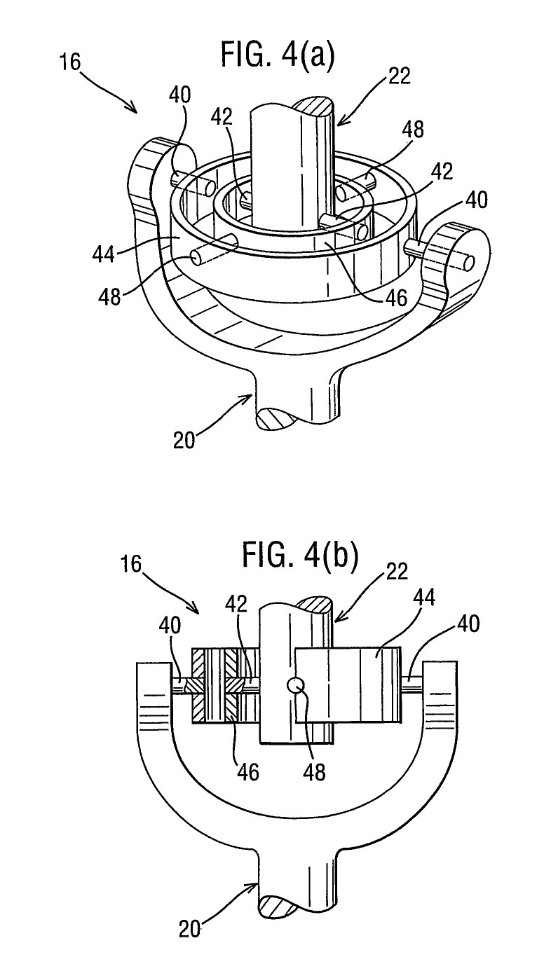

FIGS. 4(a) and (b) illustrate another embodiment of the CV coupling of one gyroscopic rotor unit of the drive system of FIG. 1; and

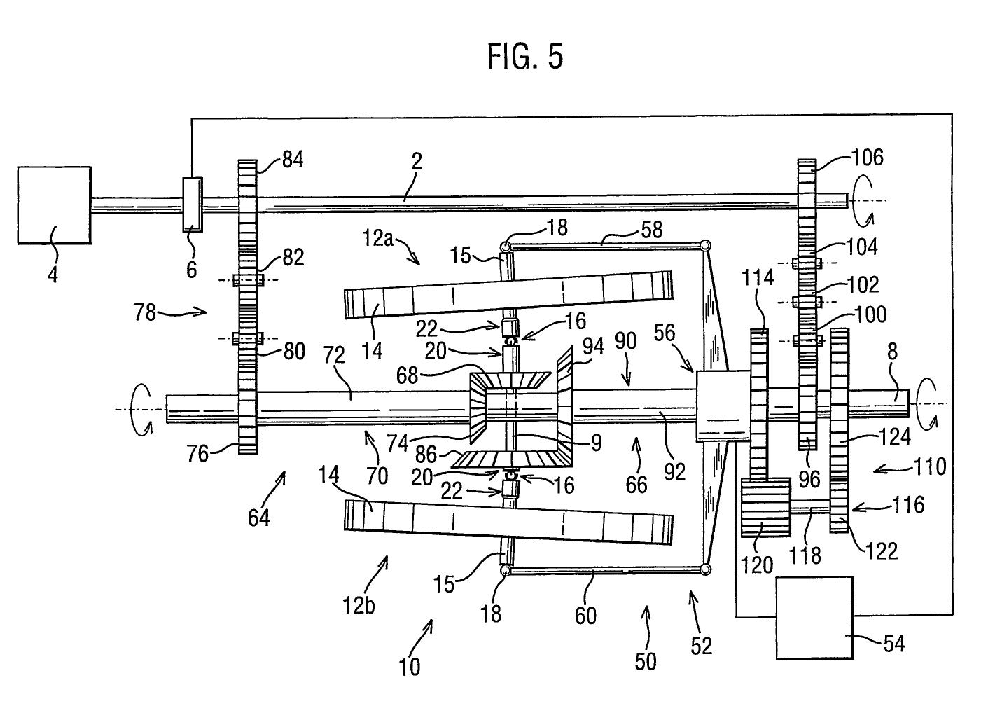

FIG. 5 schematically illustrates the drive system of FIG. 1, where in the precessional driving configuration.

The drive system comprises an input shaft 2 to which an input, in this embodiment a high-speed, low-torque input, is applied. In this embodiment the input shaft 2 is driven by a drive unit 4, which is coupled to the input shaft 2 through a clutch 6.

The drive system further comprises an output shaft 8 from which an output, in this embodiment as a low-speed, high-torque output, is delivered. The output shaft 8 includes a drive pin 9, which extends radially therethrough, the purpose of which will become apparent hereinbelow.

The drive system further comprises a gyroscopic drive assembly 10, which is operably coupled to the input shaft 2 such as to receive an input therefrom, and the output shaft 8 such as to provide an output thereto.

The gyroscopic drive assembly 10 comprises at least one gyroscopic rotor unit 12, which is operably coupled to the output shaft 8 such as to drive the same on precessing the at least one gyroscopic rotor unit 12 through the application of a control force thereto.

In this embodiment the gyroscopic drive assembly 10 comprises first and second gyroscopic rotor units 12a, 12b, which are disposed in opposed relation about the output shaft 8 and coupled to the opposite ends of the drive pin 9 extending radially from the output shaft 8, with the gyroscopic rotor units 12a, 12b being coupled to the drive pin 9 such as to provide for independent rotation of the gyroscopic rotor units 12a, 12b about the drive pin 9, that is, about a rotation axis orthogonal to the rotation axis of the output shaft 8, and rotation in unison, together with the output shaft 8, about the rotation axis of the output shaft 8.

Each of the gyroscopic rotor units 12a, 12b comprises a gyroscopic rotor 14, which includes a rotor shaft 15, which defines a rotation axis about which the gyroscopic rotor 14 is rotatable, a first, CV coupling 16, which couples one end of the rotor shaft 15 of the gyroscopic rotor 14 to the respective end of the drive pin 9 and is configured to accommodate tilting of the gyroscopic rotor 14 such that the rotation axis thereof is maintained in a plane including the rotation axis of the output shaft 8, and a second, control coupling 18, which is coupled to the other end of the rotor shaft 15 of the gyroscopic rotor 14 to which a control force is applied to produce a torque in the rotor shaft 15 of the gyroscopic rotor 14, which results in tilting of the gyroscopic rotor 14 and causes precession of the respective gyroscopic rotor unit 12a, 12b.

In this embodiment, as illustrated in FIGS. 3(a) to (c), the CV coupling 16 comprises a first coupling arm 20, which is coupled to the respective end of the drive pin 9 extending radially from the output shaft 8, a second coupling arm 22, which is coupled to the one end of the rotor shaft 15 of the gyroscopic rotor 14 of the respective gyroscopic rotor unit 12a, 12b, and a coupling element 24, which couples the first and second coupling arms 20, 22 such as to provide for tilting of the second coupling arm 22 relative to the first coupling arm 20.

The first coupling arm 20 comprises a cavity 26, in this embodiment a part-spherical cavity, in which the coupling element 24, which has a spherical body 34, as will be described in more detail hereinbelow, is captively disposed, and a pair of opposed guide slots 28, 28 in which a first pair of oppositely-directed guide pins 36, 36 of the coupling element 24 are located, as also will be described in more detail hereinbelow.

The second coupling arm 22 comprises a cavity 30, in this embodiment a part-spherical cavity, in which the coupling element 24, which has a spherical body 34 as will be described in more detail hereinbelow, is captively disposed, and a pair of opposed guide slots 32, 32, which are located on an axis orthogonal to an axis including the pair of guide slots 28, 28 in the first coupling arm 20, in which a second pair of oppositely-directed guide pins 38, 38 on the coupling element 24 are located, as will be described in more detail hereinbelow.

The coupling element 24 comprises a spherical body 34, and first and second oppositely-directed pairs of guide pins 36, 36, 38, 38 extending from the spherical body 34, with the pairs of guide pins 36, 36, 38, 38 extending in orthogonal relationship.

In another, alternative embodiment, as illustrated in FIGS. 4(a) and (b), the CV coupling 16 could comprise a first coupling arm 20, which is coupled to the respective end of the drive pin 9 extending radially from the output shaft 8, a second coupling arm 22, which is coupled to the one end of the rotor shaft 15 of the gyroscopic rotor 14 of the respective gyroscopic rotor unit 12a, 12b, and a coupling element 24, which couples the first and second coupling arms 20, 22 such as to provide for tilting of the second coupling arm 22 relative to the first coupling arm 20.

The first coupling arm 20 comprises a pair of opposed connection elements 40, 40, which provide for a pivoting connection to the coupling element 24 in a first pivot axis.

The second coupling arm 20 comprises a pair of oppositely-directed connection elements 42, 42, which provide for a pivoting connection to the coupling element 24 in the first pivot axis.

The coupling element 24 comprises first and second concentric annular elements 44, 46, with the first, outer annular element 44 being pivotally connected to the pair of connection elements 40, 40 on the first coupling arm 20, the second, inner annular element 46 being pivotally connected to the pair of connection elements 42, 42 on the second coupling arm 20, and the first and second annular elements 44, 46 being pivotally connected by a pair of opposed connection elements 48, 48 in a second pivot axis, which is orthogonal to the first pivot axis.

The gyroscopic drive assembly 10 further comprises a control unit 50, for applying a control force to the rotor shafts 15, 15 of the gyroscopic rotors 14, 14 of the first and second gyroscopic rotor units 12a, 12b, the application of which control force acts forcibly to tilt the gyroscopic rotors 14, 14 and produce a torque, which is such as to cause precessing of the first and second gyroscopic rotor units 12a, 12b about the rotation axis of the output shaft 8, and thereby drive the output shaft 8. In this embodiment the control unit 50 is operable to apply a control force to the rotor shafts 15, 15 of the gyroscopic rotors 14, 14 of the first and second gyroscopic rotor units 12a, 12b in one of one sense, as represented by arrows A in FIG. 1, or the other, opposite sense, as represented by arrows B in FIG. 1, where the application of a control force to the rotor shafts 15, 15 of the gyroscopic rotors 14, 14 of the first and second gyroscopic rotor units 12a, 12b in the one sense acts to cause precessional rotation of the first and second gyroscopic rotor units 12a, 12b in one sense, and thereby drive the output shaft 8 in the one sense, and the application of a control force to the rotor shafts 15, 15 of the gyroscopic rotors 14, 14 of the first and second gyroscopic rotor units 12a, 12b in the other sense acts to cause precessional rotation of the first and second gyroscopic rotor units 12a, 12b in the other, opposite sense, and thereby drive the output shaft 8 in the other, opposite sense.

The control unit 50 comprises a loading mechanism 52 for applying a control force to the rotor shafts 15, 15 of the gyroscopic rotors 14, 14 of the first and second gyroscopic rotor units 12a, 12b and produce a torque, which is such as to precess the first and second gyroscopic rotor units 12a, 12b, and a controller 54 for controlling both the direction and degree of the control force, such as to control the sense of rotation and the speed of the output shaft 8.

The loading mechanism 52 comprises a body 56, which is disposed about the output shaft 8 such as to be rotatable therewith, as will be described in more detail hereinbelow, and be slideable in one of one direction, as represented by arrow X in FIG. 1, to apply a control force to the rotor shafts 15, 15 of the gyroscopic rotors 14, 14 of the first and second gyroscopic rotor units 12a, 12b in the one sense, and the other, opposite direction, as represented by arrow Y in FIG. 1, to apply a control force to the rotor shafts 15, 15 of the gyroscopic rotors 14, 14 of the first and second gyroscopic rotor units 12a, 12b in the other, opposite sense, and first and second loading links 58, 60, which couple the body 56 to the respective ones of the first and second gyroscopic rotor units 12a, 12b, in this embodiment each through the control coupling 18 thereof, to apply a precessing torque to the rotor shafts 15, 15 of the gyroscopic rotors 14, 14 of the first and second gyroscopic rotor units 12a, 12b on sliding of the body 56.

In this embodiment the loading mechanism 52 includes an actuator, typically a hydraulically-driven actuator, which is operable to slide the body 56 under the control of the controller 54. In an alternative embodiment the loading mechanism 52 could be manually operated through the provision of a lever.

The drive system further comprises first and second rotor drive assemblies 64, 66, which operably couple the input shaft 2 to respective ones of the gyroscopic rotors 14, 14 of the first and second gyroscopic rotor units 12a, 12b, such as to provide for rotation of the gyroscopic rotors 14, 14 on rotation of the input shaft 2, with the rotation of the gyroscopic rotors 14, 14 of the first and second gyroscopic rotor units 12a, 12b being in opposite senses.

In this embodiment the first rotor drive assembly 64, which operably couples the input shaft 2 to the gyroscopic rotor 14 of the first gyroscopic rotor unit 12a comprises a geared coupling. The geared coupling comprises a first gear 68, here a bevel gear, which is fixed to the first coupling arm 20 of the CV coupling 16 of the first gyroscopic rotor unit 12a, a gear element 70, which comprises a sleeve 72, which is rotatably disposed about the output shaft 8 and includes second and third gears 74, 76 fixed thereto, with the second gear 74, here a bevel gear, engaging the first gear 68, and a gear train 78 comprising fourth, fifth and sixth gears 80, 82, 84, with the fourth gear 80 engaging the third gear 76, the fifth gear 82 engaging the fourth gear 80 and the sixth gear 84 being fixed to the input shaft 2 and engaging the fifth gear 82.

In this embodiment the second rotor drive assembly 66, which operably couples the input shaft 2 to the gyroscopic rotor 14 of the second gyroscopic rotor unit 12b comprises a geared coupling. The geared coupling comprises a first gear 86, here a bevel gear, which is fixed to the first coupling arm 20 of the CV coupling 16 of the second gyroscopic rotor unit 12b, a gear element 90, which comprises a sleeve 92, which is rotatably disposed about the output shaft 8 and within the body 56 of the loading mechanism 52 and includes second and third gears 94, 96 fixed thereto, with the second gear 94, here a bevel gear, engaging the first gear 86, and a gear train 98 comprising fourth, fifth, sixth and seventh gears 100, 102, 104, 106, with the fourth gear 100 engaging the third gear 96, the fifth gear 102 engaging the fourth gear 100, the sixth gear 104 engaging the fifth gear 102 and the seventh gear 106 being fixed to the input shaft 2 and engaging the sixth gear 104.

In this embodiment the drive system further comprises a drive coupling assembly 110, which rotatably couples the body 56 of the loading mechanism 52 to the output shaft 8 such that the body 56 of the loading mechanism 52 and the output shaft 8 rotate in unison. The drive coupling assembly 110 comprises a geared coupling, which comprises a first gear 114, which is fixed to the body 56 of the loading mechanism 52, a gear element 116, which comprises a shaft 118, which is disposed in parallel relation to the output shaft 8 and includes second and third gears 120, 122 fixed thereto, with the second gear 120 engaging the first gear 114, and a fourth gear 124, which is fixed to the output shaft 8 and engages the third gear 122.

Operation of the drive system will now be described hereinbelow.

In a first, non-driving state, as illustrated in FIG. 1, the drive unit 4 acts, through the input shaft 2, and the first and second rotor drive assemblies 64, 66, to rotate the gyroscopic rotors 14, 14 of the first and second gyroscopic rotor units 12a, 12b, with the developed inertia of each of the gyroscopic rotors 14, 14 being maintained as energy stores. In one embodiment the gyroscopic rotors 14, 14 would be maintained at a predetermined speed to provide for a predetermined output at the output shaft 8.

In one embodiment, and particularly for vehicular application, the drive unit 4 could be the prime mover, with the drive system being an auxiliary drive system, which is maintained to provide for an instantaneous high-torque output at the output shaft 8. It is envisaged that the drive system would find particular application in relation to vehicles, which are required to stop and start frequently, such as encountered in city traffic through congestion.

When an output is required from the drive system, the user operates the control unit 50 to request an output from the drive system, in this embodiment by operating the controller 54 to request an output at the output shaft 8.

On requesting an output, the controller 54 actuates the loading mechanism 52, which through the action of sliding the body 56 thereof, acts to apply a control force to the rotor shafts 15, 15 of the gyroscopic rotors 14, 14 of the first and second gyroscopic rotor units 12a, 12b. The application of a control force to the rotor shafts 15, 15 of the gyroscopic rotors 14, 14 of the first and second gyroscopic rotor units 12a, 12b produces a torque in the rotor shafts 15, 15 of the gyroscopic rotors 14, 14, which is such as to cause precessing of the first and second gyroscopic rotor units 12a, 12b about the rotational axis of the output shaft 8 in one sense, and thereby drives the output shaft 8 in the one sense. FIG. 5 illustrates the configuration of the drive system where a control force is being applied to the rotor shafts 15, 15 of the gyroscopic rotors 14, 14 of the first and second gyroscopic rotor units 12a, 12b in one “forward” direction, this providing for precessional rotation of the first and second gyroscopic rotor units 12a, 12b about the rotational axis of the output shaft 8 in the sense, which provides for forward driving of the output shaft 8. As mentioned hereinabove, the drive system provides for the application of a control force to the rotor shafts 15, 15 of the gyroscopic rotors 14, 14 of the first and second gyroscopic rotor units 12a, 12b in the other, “reverse” direction, this providing for precessional rotation of the first and second gyroscopic rotor units 12a, 12b about the rotational axis of the output shaft 8 in the opposite sense, which provides for reverse driving of the output shaft 8.

On returning the controller 54 to the non-driving state, the drive unit 4 acts, through the input shaft 2 and the first and second rotor drive assemblies 64, 66, to re-charge the gyroscopic rotors 14, 14 of the first and second gyroscopic rotor units 12a, 12b by rotating the gyroscopic rotors 14, 14 to achieve the predetermined speed. With such re-charging of the gyroscopic rotors 14, 14, the drive system can be used repeatedly to provide for a high-torque output at the output shaft 8.

In one embodiment the first and second gyroscopic rotor units 12a, 12b can be utilized to achieve braking of the output shaft 8. By reversing the direction of the control force from that applied during normal drive, in this embodiment through operation of the controller 54, energy is returned to the gyroscopic rotors 14, 14, where acting as flywheels, of the first and second gyroscopic rotor units 12a, 12b. Such energy conversion can result in the gyroscopic rotors 14, 14 of the first and second gyroscopic rotor units 12a, 12b having a speed in excess of that of the normal driving speed achieved by the input from the input shaft 2. In this embodiment the drive unit 4 is disengaged from the input shaft 2 during such braking of the output shaft 8 by operation of the clutch 6.

Finally, it will be understood that the present invention has been described in its preferred embodiments and can be modified in many different ways without departing from the scope of the invention as defined by the appended claims.

1. A drive system, comprising:
an output shaft, which is rotatable about a rotation axis, and from which an output is in use delivered; and
at least one gyroscopic rotor unit, which is operably coupled to the output shaft such as to drive the output shaft on effecting precessional rotation of the at least one gyroscopic rotor unit about the rotation axis of the output shaft.

2. The drive system of claim 1, wherein the at least one gyroscopic rotor unit comprises a gyroscopic rotor, which, on applying a control force thereto in a plane including the rotation axis of the output shaft, effects precessional rotation of the at least one gyroscopic rotor unit about the rotation axis of the output shaft.

3. The drive system of claim 2, wherein the at least one gyroscopic rotor unit further comprises a CV coupling, which couples the gyroscopic rotor thereof to the output shaft such as to enable rotation of the gyroscopic rotor on applying a control force thereto in the plane including the rotation axis of the output shaft and effect rotation of the output shaft with precessional rotation of the at least one gyroscopic rotor unit about the rotation axis of the output shaft.

4. The drive system of claim 3, wherein the CV coupling includes a first coupling member, which is rotatably coupled to the output shaft about a rotation axis orthogonal to the rotation axis of the output shaft, a second coupling member, which is fixed to the gyroscopic rotor, and a coupling element, which couples the first and second coupling members such that the gyroscopic rotor is rotated on rotating the first coupling member.

5. The drive system of claim 4, further comprising:
at least one rotor drive assembly, which is coupled to the first coupling member of the CV coupling such as to provide for rotation of the gyroscopic rotor.

6. The drive system of claim 2, wherein the gyroscopic rotor is configured such as to provide for application of a control force in one of two opposite senses, whereby the application of a control force in one sense effects precessional rotation of the at least one gyroscopic rotor unit about the rotation axis of the output shaft in one sense, thereby driving the output shaft in the one sense, and the application of a control force in the other sense effects precessional rotation of the at least one gyroscopic rotor unit about the rotation axis of the output shaft in the other sense, thereby driving the output shaft in the other sense.

7. The drive system of claim 2, further comprising:
a control mechanism, which is operable to apply a control force to the gyroscopic rotor of the at least one gyroscopic rotor unit, and thereby control the output at the output shaft.

8. The drive system of claim 7, wherein the control mechanism comprises a loading body, which is rotatably and slideably disposed about the output shaft, and at least one loading link, which operably couples the loading member to the gyroscopic rotor of the at least one gyroscopic rotor unit, whereby sliding the loading body axially relative to the output shaft acts to apply a control force to the gyroscopic rotor of the at least one gyroscopic rotor unit.

9. The drive system of claim 8, further comprising:
a drive coupling assembly, which rotatably couples the loading body of the loading mechanism to the output shaft such that the loading body of the loading mechanism and the output shaft rotate in unison.

10. The drive system of claim 2, comprising:
first and second gyroscopic rotor units disposed in opposed relation about the output shaft, each comprising a gyroscopic rotor, wherein the gyroscopic rotors are rotated in opposite senses and, on application of a control force to each of the gyroscopic rotors in a plane including the rotation axis of the output shaft, effect precessional rotation of the respective gyroscopic rotor units about the rotation axis of the output shaft.

11. A method of driving an output shaft, the method comprising the steps of:
providing a drive system including an output shaft, which is rotatable about a rotation axis, and at least one gyroscopic rotor unit, which is operably coupled to the output shaft; and
effecting precessional rotation of the at least one gyroscopic rotor unit about the rotation axis of the output shaft such as to drive the output shaft.

12. The method of claim 11, wherein:
the at least one gyroscopic rotor unit comprises a gyroscopic rotor; and
the step of effecting precessional rotation comprises the step of:
applying a control force to the gyroscopic rotor of the at least one gyroscopic rotor unit in a plane including the rotation axis of the output shaft, which is such as to effect precessional rotation of the at least one gyroscopic rotor unit about the rotation axis of the output shaft.

13. The method of claim 12, wherein:
the drive system comprises first and second gyroscopic rotor units disposed in opposed relation about the output shaft, each comprising a gyroscopic rotor, and the gyroscopic rotors being rotated in opposite senses; and
the step of effecting precessional rotation comprises the step of:
applying a control force to the gyroscopic rotors of the gyroscopic rotor units in a plane including the rotation axis of the output shaft, which is such as to effect precessional rotation of the gyroscopic rotor units about the rotation axis of the output shaft.

14. A CV coupling, comprising:
a first coupling member for coupling to a first body and including a pair of opposed connection elements for providing a pivoting connection about a first pivot axis;
a second coupling member for coupling to a second body and including a pair of oppositely-directed connection elements for providing a pivoting connection about the first pivot axis; and
a coupling element, which couples the first and second coupling members, wherein the coupling element comprises first and second concentric annular members, with the first, outer annular member being pivotally connected to the pair of connection elements on the first coupling member and the second, inner annular member being pivotally connected to the pair of connection elements on the second coupling member, and a pair of opposed connection elements for providing a pivoting connection between the annular members about a second pivot axis, which is orthogonal to the first pivot axis.

15. A CV coupling, comprising:
a first coupling member for coupling to a first body and including a part-spherical cavity and a pair of opposed guide slots;
a second coupling member for coupling to a second body and including a part-spherical cavity and a pair of opposed guide slots; and
a coupling element, which couples the first and second coupling members, wherein the coupling element comprises a spherical body, which is captively disposed in the cavities of the first and second coupling members, a first pair of oppositely-directed guide pins located in the pair of opposed guide slots in the first coupling member, and a second pair of oppositely-directed guide pins, disposed in orthogonal relationship to the first pair of oppositely-directed guide pins, located in the pair of opposed guide slots in the second coupling member.

16-18. (canceled)
